(19) United States
(12) Patent Application Publication
(10) Pub. No.: US 2012/0242600 A1
(43) Pub. Date: Sep. 27, 2012

(54) TOUCH OPERATING DISPLAY DEVICE

(76) Inventor: Jeng-Maw CHIOU, Hsinchu (TW)

(21) Appl. No.: 13/412,223

(22) Filed: Mar. 5, 2012

(30) Foreign Application Priority Data
Mar. 24, 2011 (TW) 100110082

(51) Int. Cl. G06F 3/041

(52) U.S. Cl. 345/173

(57) ABSTRACT

A touch operating display device is disclosed, including: a back light device; a first polarizing film disposed on the back light device; an operating device disposed on the first polarizing film; a liquid crystal layer disposed on the operating device; a first transparent conductive layer disposed on the liquid crystal layer; an interval layer disposed on the first transparent conductive layer; a second transparent conductive layer disposed on the interval layer; and a second polarizing film disposed on the second transparent conductive layer.

### BACKGROUND OF THE INVENTION

This Application claims priority of Taiwan Patent Application No. 100110082, filed on Mar. 24, 2011, the entirety of which is incorporated by reference herein.

1. Field of the Invention

The present invention relates generally to a liquid crystal display device and more particularly to a touch display device.

2. Description of the Related Art

Because touch panels can be applied to portable products and have advantages of easy operation, they are widely used in various electronic products, including personal digital assistants (PDA), palm sized PC, cell phones, hand-writing devices, information appliances, automated teller machines (ATM), and point of sales (POS), etc. Portable communication and consumer devices are widely used and these devices use touch panels as input devices. Thus, many businesses have joined in the development of touch panels.

FIG. 1 shows a liquid crystal display device having touch operating functions, which, from a bottom side to a top side, includes a circuit board 102, a backlight device 104, a first light polarizing film 106, a first glass 108, thin film transistors 110, a liquid crystal layer 112, a third transparent conductive layer 114, a color filter layer 116, a second glass 118, a second transparent conductive layer 120, an insulating layer 122, a first transparent conductive layer 124, a second light polarizing film 126 and a cover substrate 128. Although this liquid crystal display device can use a sensing device including the first transparent conductive layer 124, the insulating layer 122 and the second transparent conductive layer 120 to perform touch operating functions, the weights and thicknesses thereof, should be improved,when used in communication and consumer electronic products.

### BRIEF SUMMARY OF INVENTION

The invention provides a touch operating display device, comprising: a back light device; a first polarizing film disposed on the back light device; an operating device disposed on the first polarizing film; a liquid crystal layer disposed on the operating device; a first transparent conductive layer disposed on the liquid crystal layer; an interval layer disposed on the first transparent conductive layer; a second transparent conductive layer disposed on the interval layer; and a second polarizing film disposed on the second transparent conductive layer.

The invention further provides a touch operating display device, comprising: a back light device; a first polarizing film disposed on the back light device; an operating device disposed on the first polarizing film; a liquid crystal layer disposed on the operating device; an interval layer disposed over the liquid crystal layer; a first transparent conductive layer and an insulating layer disposed on the interval layer, wherein the first transparent conductive layer comprises strip-shaped structures extending along a first direction, and the first transparent conductive layer comprises strip-shaped electrodes extending along a second direction; a connection layer disposed on the insulating layer, connecting to the strip-shaped electrodes disposed on two sides of the insulating layer; a second transparent conductive layer disposed between the interval layer and the liquid crystal layer; and a second transparent conductive layer disposed on the first transparent conductive layer.

### BRIEF DESCRIPTION OF DRAWINGS

The invention can be more fully understood by reading the subsequent detailed description and examples with references made to the accompanying drawings, wherein,

FIG. 1 shows a liquid crystal display device having touch operating functions.

FIG. 2 shows a sketch drawing of a field sequential color (FSC) liquid crystal display device of an embodiment of the invention.

FIG. 3 shows the arrangement of the back light device and the thin film transistor array of an embodiment of the invention.

FIG. 4 shows a liquid crystal display device comprising a touch operating device of the first embodiment of the invention.

FIG. 5 shows a liquid crystal display device comprising a touch operating device of the second embodiment of the invention.

FIG. 6 shows a liquid crystal display device comprising a touch operating device of the third embodiment of the invention.

FIG. 7 shows a liquid crystal display device comprising a touch operating device of the fourth embodiment of the invention.

FIG. 8 shows a liquid crystal display device comprising a touch operating device of the fifth embodiment of the invention.

FIG. 9 shows a liquid crystal display device comprising a touch operating device of the sixth embodiment of the invention.

FIG. 10 shows a liquid crystal display device comprising a touch operating device of the seventh embodiment of the invention.

FIG. 11 shows a liquid crystal display device comprising a touch operating device of the eighth embodiment of the invention.

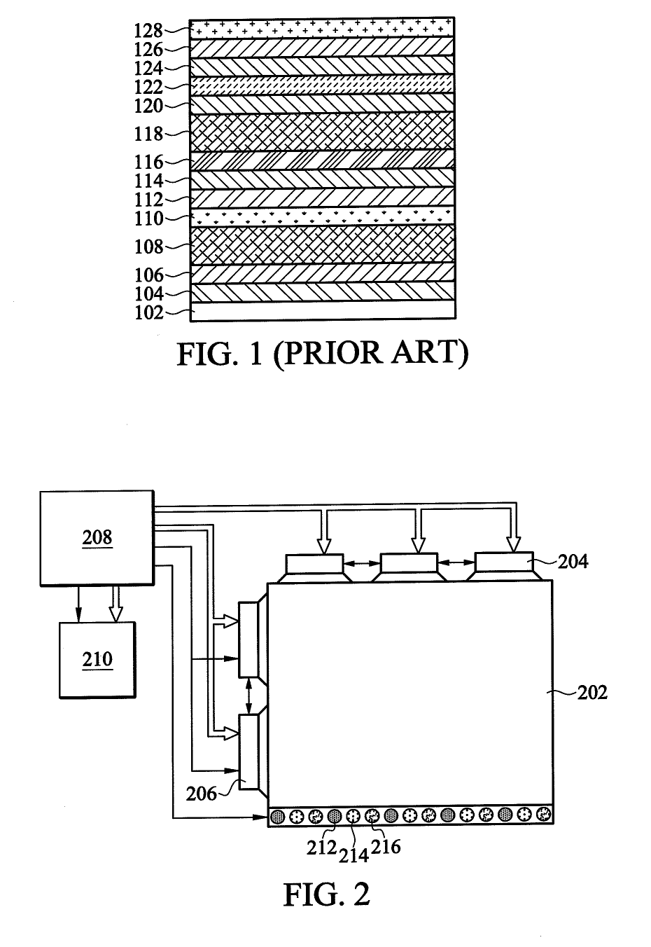

### DETAILED DESCRIPTION OF INVENTION

The invention integrates a field sequential color (FSC) device with a touch operating device. The field sequential color (FSC) device uses sequential colors to present color, wherein a color filter is not required, so that the device of the invention can be thin and light. In addition, due to using the field sequential color (FSC), product brightness can be increased.

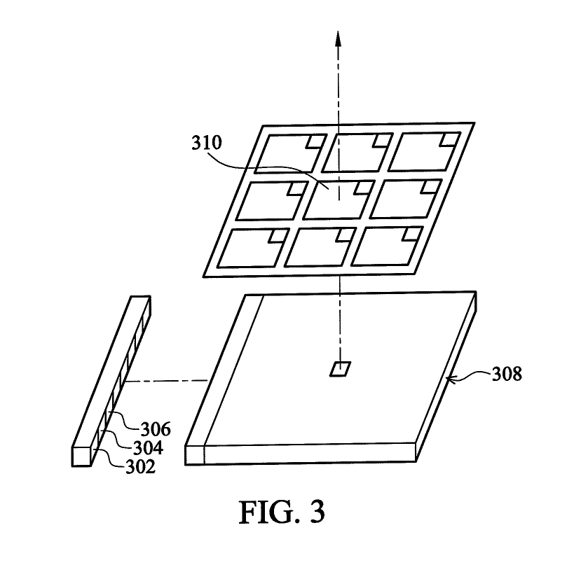

FIG. 2 shows a sketch drawing of a field sequential color (FSC) liquid crystal display device of an embodiment of the invention. Referring to FIG. 2, a liquid crystal display 202 includes a plurality of crossed gate lines and data lines (not shown), wherein thin film transistors drive liquid crystals disposed at the cross of the gate lines and data lines. A source driving IC 204 is used to generate the driving signals of data lines of the liquid crystal display. A gate driving IC 206 is used to generate the driving signals of gate lines of the liquid crystal display. A time schedule controller 208 is used to generate driving signals of the gate driving ICs, and generate input signals and data signals for driving source drive ICs. A memory 210 is used to store and read signal data. In addition, the FSC type device further includes an array of a red light emitting diode 212, green light emitting diode 214, and blue light emitting diode 216 as a back light device. The arrangement of the back light device and the thin film transistor array of an embodiment of the invention are more clearly illustrated in accordance with FIG. 3. Referring to FIG. 3, the FSC type back light device comprises an array including red light emitting diodes 302, green light emitting diodes 304 and blue light emitting diodes 306 and a light guiding plate 308. In order to present field sequential colors, a color sub-pixel corresponds to a control unit 310 of a thin film transistor (TFT). The back light device shown in FIG. 3 can be applied to the embodiments illustrated below.

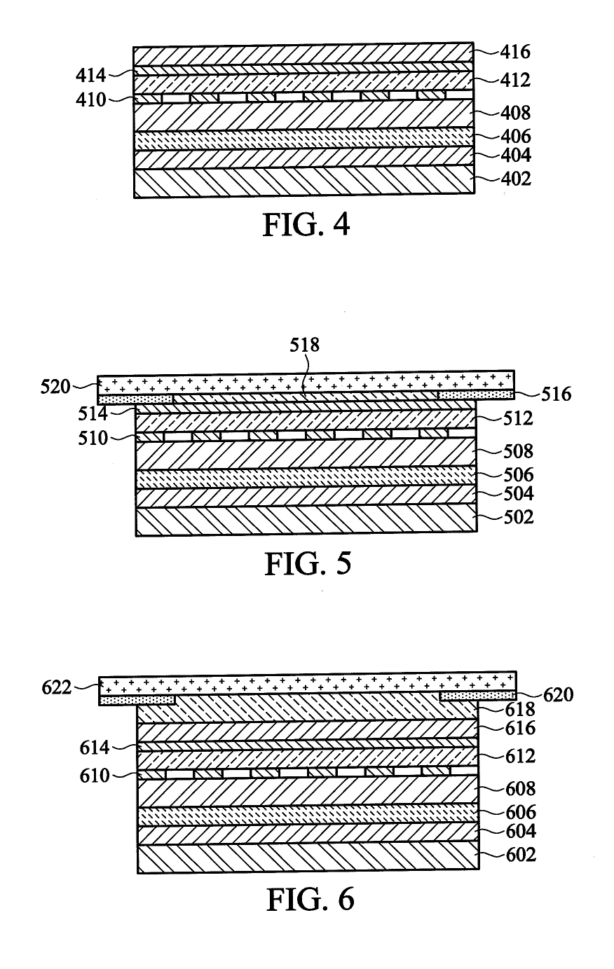

A liquid crystal display device comprising a touch operating device of the first embodiment of the invention is illustrated in accordance with FIG. 4. The embodiment integrates a double side ITO (DITO) type touch operating device with an FSC liquid crystal display device. Referring to FIG. 4, a back light device 402 is provided, wherein the back light device 402 can be a back light device comprising the array of light emitting diodes disclosed in FIG. 3. A first polarizing film 404 is disposed over the back light device 402. An operating device 406 is disposed on the first polarizing film 404. In an embodiment of the invention, the operating device 406 is a thin film transistor (TFT). A liquid crystal layer 408 is disposed on the operating device 406. In an embodiment of the invention, for the liquid crystal layer 408 to have enough response speed to achieve requirements of FSC liquid crystal display devices, the liquid crystal layer 408 preferably is an optically compensated bend (OCB) liquid crystal layer. A first transparent conductive layer 410 is disposed on the liquid crystal layer 408. In an embodiment of the invention, the first transparent conductive layer 410 comprises strip-shaped electrodes extending along a direction, such as direction x, and the first transparent conductive layer 410 can be formed of indium tin oxide (ITO) or indium zinc oxide (IZO). A second transparent conductive layer 414 is disposed over the first transparent conductive layer 410 with an interval layer 412 between the first transparent conductive layer 410 and the second transparent conductive layer 414. The second transparent conductive layer 414 comprises strip-shaped electrodes extending along a direction, such as direction y, and the second transparent conductive layer 414 can be formed of indium tin oxide (ITO) or indium zinc oxide (IZO). The interval layer 412 can be formed of glass. A second polarizing film 416 is disposed on the second transparent conductive layer 414. The first transparent conductive layer 410, the interval layer 412 and the second transparent conductive layer 414 are used as a touch operating sensor, so that the liquid crystal display device of the embodiment can have the function of touch operation. It is noted that the FSC liquid crystal display device and the touch operating device together use a transparent conductive layer, i.e. the first transparent conductive layer 410, to save process steps and costs.

A liquid crystal display device comprising a touch operating device of the second embodiment of the invention is illustrated in accordance with FIG. 5. The embodiment integrates a double side ITO (DITO) type touch operating device with an FSC liquid crystal display device. The difference between the liquid crystal display device of the embodiment and the liquid crystal display device disclosed in the first embodiment is that the embodiment further comprises an ink layer and optics glue between the second transparent conductive layer and the second polarizing film. Referring to FIG. 5, a back light device 502 is provided, wherein the back light device 502 can be a back light device comprising of the array of light emitting diodes disclosed in FIG. 3. A first polarizing film 504 is disposed over the back light device 502. An operating device 506 is disposed on the first polarizing film 504. In an embodiment of the invention, the operating device 506 is a thin film transistor (TFT). A liquid crystal layer 508 is disposed on the operating device 506. In an embodiment of the invention, for the liquid crystal layer 508 to have enough response speed to achieve requirements of FSC liquid crystal display devices, the liquid crystal layer 508 preferably is an optically compensated bend (OCB) liquid crystal layer. A first transparent conductive layer 510 is disposed on the liquid crystal layer 508. In an embodiment of the invention, the first transparent conductive layer 510 comprises strip-shaped electrodes extending along a direction, such as direction x, and the first transparent conductive layer 510 can be formed of indium tin oxide (ITO) or indium zinc oxide (IZO). In an embodiment of the invention, a black matrix layer is disposed between the first transparent conductive layer 510 and the liquid crystal layer 508 to clarify a pixel definition. A second transparent conductive layer 514 is disposed over the first transparent conductive layer 510 with an interval layer 512 between the first transparent conductive layer 510 and the second transparent conductive layer 514. The second transparent conductive layer 514 comprises strip-shaped electrodes extending along a direction, such as direction y, and the second transparent conductive layer 514 can be formed of indium tin oxide (ITO) or indium zinc oxide (IZO). The interval layer 512 can be formed of glass. A second polarizing film 520 is disposed on the second transparent conductive layer 514. The first transparent conductive layer 510, the interval layer 512 and the second transparent conductive layer 514 are used as a touch operating sensor, so that the liquid crystal display device of the embodiment can have the function of touch operation. An ink layer 516 and optics glue 518 are disposed between the second transparent conductive layer 514 and the second polarizing film 520, wherein the ink layer 516 is used to cover the periphery circuit in the non-display region.

A liquid crystal display device comprising a touch operating device of the third embodiment of the invention is illustrated in accordance with FIG. 6. The embodiment integrates a double side ITO (DITO) type touch operating device with an FSC liquid crystal display device. The difference between the liquid crystal display device of the embodiment and the liquid crystal display device disclosed in the first embodiment is that the embodiment further comprises a cover on the second polarizing film. Referring to FIG. 6, a back light device 602 is provided, wherein the back light device 602 can be the back light device comprising the array of light emitting diodes disclosed in FIG. 3. A first polarizing film 604 is disposed over the back light device 602. An operating device 606 is disposed on the first polarizing film 604. In an embodiment of the invention, the operating device 606 is a thin film transistor (TFT). A liquid crystal layer 608 is disposed on the operating device 606. In an embodiment of the invention, for the liquid crystal layer 608 to have enough response speed to achieve requirements of FSC liquid crystal display devices, the liquid crystal layer 608 preferably is an optically compensated bend (OCB) liquid crystal layer. A first transparent conductive layer 610 is disposed on the liquid crystal layer 608. In an embodiment of the invention, the first transparent conductive layer 610 comprises strip-shaped electrodes extending along a direction, such as direction x, and the first transparent conductive layer 610 can be formed of indium tin oxide (ITO) or indium zinc oxide (IZO). A second transparent conductive layer 614 is disposed over the first transparent conductive layer 610 with an interval layer 612 between the first transparent conductive layer 610 and the second transparent conductive layer 614. The second transparent conductive layer 614 comprises strip-shaped electrodes extending along a direction, such as direction y, and the second transparent conductive layer 614 can be formed of indium tin oxide (ITO) or indium zinc oxide (IZO). The interval layer 612 can be formed of glass. A second polarizing film 616 is disposed on the second transparent conductive layer 614. The first transparent conductive layer 610, the interval layer 612 and the second transparent conductive layer 614 are used as a touch operating sensor, so that the liquid crystal display device of the embodiment can have the function of touch operation. A cover 622 is disposed on the second polarizing film 616, wherein the cover 622 can be glass, polymethylmethacrylate (PMMA) or a transparent thin film. An ink layer 620 and optics glue 618 are disposed between the cover 622 and the second polarizing film 616, wherein the ink layer 620 is used to cover the periphery circuit in the non-display region.

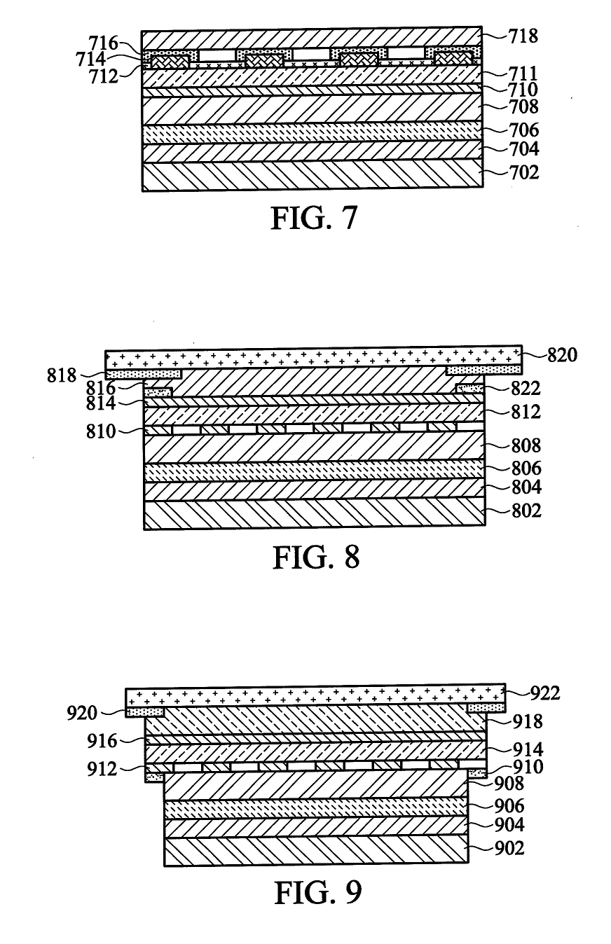

A liquid crystal display device comprising a touch operating device of the fourth embodiment of the invention is illustrated in accordance with FIG. 7. The difference between the liquid crystal display device of the embodiment and the liquid crystal display device disclosed in the first embodiment is that the embodiment integrates a single side ITO (SITO) type touch operating device with an FSC liquid crystal display device. Referring to FIG. 7, a back light device 702 is provided, wherein the back light device 702 can be the back light device 702 comprising the array of light emitting diodes disclosed in FIG. 3. A first polarizing film 704 is disposed over the back light device 702. An operating device 706 is disposed on the first polarizing film 704. In an embodiment of the invention, the operating device 706 is a thin film transistor (TFT). A liquid crystal layer 708 is disposed on the operating device 706. In an embodiment of the invention, for the liquid crystal layer 708 to have enough response speed to achieve requirements of FSC liquid crystal display devices, the liquid crystal layer 708 preferably is an optically compensated bend (OCB) liquid crystal layer. A second transparent conductive layer 710 is disposed on the liquid crystal layer 708. The second transparent conductive layer 710 can be formed of indium tin oxide (ITO) or indium zinc oxide (IZO). An interval layer 711 is disposed on the second transparent conductive layer 710. The interval layer 711 can be formed of glass. A first transparent conductive layer 712 and an insulating layer 714 are disposed on the interval layer 711. The insulating layer 714 comprises strip-shaped structures extending along a direction, such as direction y, and the first transparent conductive layer 712 comprises strip-shaped electrodes extending along a direction, such as direction x. That is, the first transparent conductive layer 712 and the insulating layer 714 are perpendicular with each other. The first transparent conductive layer 712 can be formed of indium tin oxide (ITO) or indium zinc oxide (IZO). The insulating layer 714 can be formed of macromolecule material, such as epoxy or acrylic resin. A connection layer 716 is disposed on the insulating layer 714 to connect the first transparent conductive layer 712 on two sides of the insulating layer 714. The connection layer 716 can be formed of metal or transparent conducting material with a high conductivity coefficient, such as layers comprising a stack of molybdenum, aluminum and molybdenum. A second polarizing film 718 is disposed on the second transparent conductive layer 710. The first transparent conductive layer 712, the insulating layer 714 and the connection layer 716 are used as a touch operating sensor, so that the liquid crystal display device of the embodiment can have the function of touch operation.

A liquid crystal display device comprising a touch operating device of the fifth embodiment of the invention is illustrated in accordance with FIG. 8. The embodiment integrates a double side ITO (DITO) type touch operating device with an FSC liquid crystal display device. The difference between the liquid crystal display device of the embodiment and the liquid crystal display device disclosed in the second embodiment is that the embodiment further comprises a metal trace layer between the second transparent conductive layer and the ink layer. Referring to FIG. 8, a back light device 802 is provided, wherein the back light device 802 can be the back light device comprising the array of light emitting diodes disclosed in FIG. 3. A first polarizing film 804 is disposed over the back light device 802. An operating device 806 is disposed on the first polarizing film 804. In an embodiment of the invention, the operating device 806 is a thin film transistor (TFT). A liquid crystal layer 808 is disposed on the operating device 806. In an embodiment of the invention, for the liquid crystal layer 808 to have enough response speed to achieve requirements of FSC liquid crystal display devices, the liquid crystal layer 808 preferably is an optically compensated bend (OCB) liquid crystal layer. A first transparent conductive layer 810 is disposed on the liquid crystal layer 808. In an embodiment of the invention, the first transparent conductive layer 810 comprises strip-shaped electrodes extending along a direction, such as direction x, and the first transparent conductive layer 810 can be formed of indium tin oxide (ITO) or indium zinc oxide (IZO). A second transparent conductive layer 814 is disposed over the first transparent conductive layer 810 with an interval layer 812 between the first transparent conductive layer 810 and the second transparent conductive layer 814. The second transparent conductive layer 814 comprises strip-shaped electrodes extending along a direction, such as direction y, and the second transparent conductive layer 814 can be formed of indium tin oxide (ITO) or indium zinc oxide (IZO). The interval layer 812 can be formed of glass. A second polarizing film 820 is disposed on the second transparent conductive layer 814. The first transparent conductive layer 810, the interval layer 812 and the second transparent conductive layer 814 are used as a touch operating sensor, so that the liquid crystal display device of the embodiment can have the function of touch operation. An ink layer 818 and optics glue 816 are disposed between the second transparent conductive layer 814 and the second polarizing film 820, wherein the ink layer 818 is used to cover the periphery circuit in the non-display region. A metal trace layer 822 is disposed between the second transparent conductive layer 814 and the ink layer 818. Since the material, i.e. ITO and IZO, of the transparent conductive layer has relatively higher resistance, the metal trace layer 822 can provide the connections with an IC driver in the non-display region with lower resistance. In another embodiment of the invention, a first metal trace layer can be disposed between the second transparent conductive layer and the ink layer, and a second metal trace layer can be disposed under the first transparent conductive layer.

A liquid crystal display device comprising a touch operating device of the sixth embodiment of the invention is illustrated in accordance with FIG. 9. The embodiment integrates a double side ITO (DITO) type touch operating device with an FSC liquid crystal display device. The difference between the liquid crystal display device of the embodiment and the liquid crystal display device disclosed in the fifth embodiment is that the metal trace layer is disposed under the first transparent conductive layer for signal transmitting in this embodiment. Referring to FIG. 9, a back light device 902 is provided, wherein the back light device 902 can be the back light device comprising the array of light emitting diodes disclosed in FIG. 3. A first polarizing film 904 is disposed over the back light device 902. An operating device 906 is disposed on the first polarizing film 904. In an embodiment of the invention, the operating device 906 is thin film transistors (TFT). A liquid crystal layer 908 is disposed on the operating device 906. In an embodiment of the invention, for the liquid crystal layer 908 to have enough response speed to achieve requirements of FSC liquid crystal display devices, the liquid crystal layer 908 preferably is an optically compensated bend (OCB) liquid crystal layer. A first transparent conductive layer 912 is disposed on the liquid crystal layer 908. In an embodiment of the invention, the first transparent conductive layer 912 comprises strip-shaped electrodes extending along a direction, such as direction x, and the first transparent conductive layer 912 can be formed of indium tin oxide (ITO) or indium zinc oxide (IZO). A second transparent conductive layer 916 is disposed over the first transparent conductive layer 912 with an interval layer 914 between the first transparent conductive layer 912 and the second transparent conductive layer 916. The second transparent conductive layer 916 comprises strip-shaped electrodes extending along a direction, such as direction y, and the second transparent conductive layer 916 can be formed of indium tin oxide (ITO) or indium zinc oxide (IZO). The interval layer 914 can be formed of glass. A second polarizing film 922 is disposed on the second transparent conductive layer 916. The first transparent conductive layer 912, the interval layer 914 and the second transparent conductive layer 916 are used as a touch operating sensor, so that the liquid crystal display device of the embodiment can have the function of touch operation. An ink layer 920 and optics glue 918 are disposed between the second transparent conductive layer 916 and the second polarizing film 922, wherein the ink layer 920 is used to cover the periphery circuit in the non-display region. A metal trace layer 910 is disposed under the first transparent conductive layer 912. Likewise, since the material, i.e. ITO and IZO, of the transparent conductive layer has a relatively higher resistance, the metal trace layer 910 can provide connections with an IC driver in the non-display region with lower resistance.

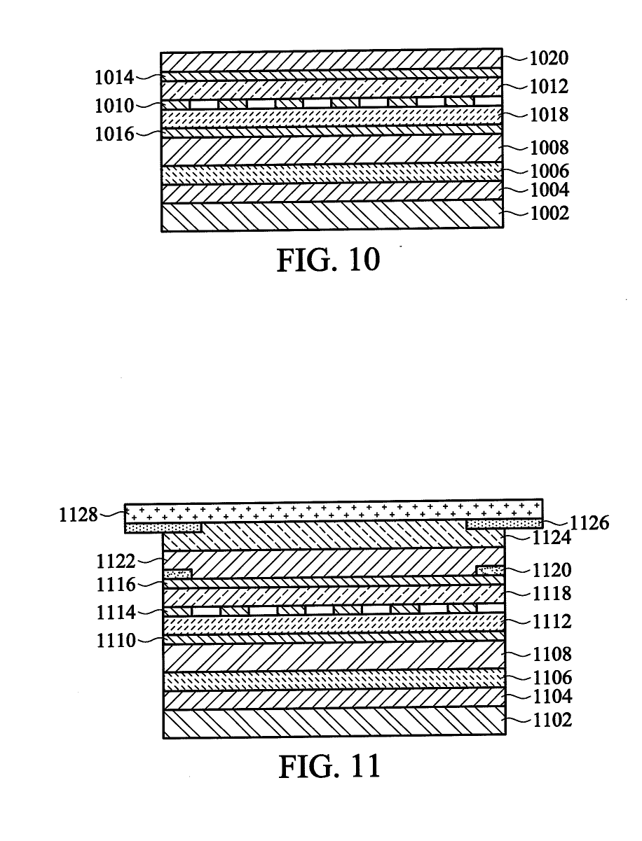

A liquid crystal display device comprising a touch operating device of the seventh embodiment of the invention is illustrated in accordance with FIG. 10. The embodiment integrates a double side ITO (DITO) type touch operating device with an FSC liquid crystal display device. The difference between the liquid crystal display device of the embodiment and the liquid crystal display device disclosed in the first embodiment is that the embodiment further comprises an insulating layer and a transparent conductive layer under the second transparent conductive layer. Referring to FIG. 10, a back light device 1002 is provided, wherein the back light device 1002 can be the back light device comprising the array of light emitting diodes disclosed in FIG. 3. A first polarizing film 1004 is disposed over the back light device 1002. An operating device 1006 is disposed on the first polarizing film 1004. In an embodiment of the invention, the operating device 1006 is a thin film transistor (TFT). A liquid crystal layer 1008 is disposed on the operating device 1006. In an embodiment of the invention, for the liquid crystal layer 1008 to have enough response speed to achieve requirements of FSC liquid crystal display devices, the liquid crystal layer 1008 preferably is an optically compensated bend (OCB) liquid crystal layer. A first transparent conductive layer 1010 is disposed on the liquid crystal layer 1008. In an embodiment of the invention, the first transparent conductive layer 1010 comprises strip-shaped electrodes extending along a direction, such as direction x, and the first transparent conductive layer 1010 can be formed of indium tin oxide (ITO) or indium zinc oxide (IZO). A second transparent conductive layer 1014 is disposed over the first transparent conductive layer 1010 with an interval layer 1012 between the first transparent conductive layer 1010 and the second transparent conductive layer 1014. The second transparent conductive layer 1014 comprises strip-shaped electrodes extending along a direction, such as direction y, and the second transparent conductive layer 1014 can be formed of indium tin oxide (ITO) or indium zinc oxide (IZO). The interval layer 1012 can be formed of glass. A third transparent conductive layer 1016 and an insulating layer 1018 are disposed between the first transparent conductive layer 1010 and the liquid crystal layer 1008. A second polarizing film 1020 is disposed on the second transparent conductive layer 1014. The first transparent conductive layer 1010, the interval layer 1012 and the second transparent conductive layer 1014 are used as a touch operating sensor, so that the liquid crystal display device of the embodiment can have the function of touch operation. It is noted that the FSC liquid crystal display device and the touch operating device uses different transparent conductive layers to increase efficiency of the display device and reduce signal interference at the thin film transistor side. For example, the FSC liquid crystal display device applies the third transparent conductive layer 1016, while the touch operating device applies the first transparent conductive layer 1010.

A liquid crystal display device comprising a touch operating device of the eighth embodiment of the invention is illustrated in accordance with FIG. 11. The embodiment integrates a double side ITO (DITO) type touch operating device with an FSC liquid crystal display device, and further integrates the liquid crystal display devices in the third, fifth and seventh embodiments to achieve a device having higher reliability. Referring to FIG. 11, a back light device 1102 is provided, wherein the back light device 1102 can be the back light device comprising the array of light emitting diodes disclosed in FIG. 3. A first polarizing film 1104 is disposed over the back light device 1102. An operating device 1106 is disposed on the first polarizing film 1104. In an embodiment of the invention, the operating device 1106 is a thin film transistor (TFT). A liquid crystal layer 1108 is disposed on the operating device 1106. In an embodiment of the invention, for the liquid crystal layer 1108 to have enough response speed to achieve requirements of FSC liquid crystal display devices, the liquid crystal layer 1108 preferably is an optically compensated bend (OCB) liquid crystal layer. A first transparent conductive layer 1114 is disposed on the liquid crystal layer 1108. In an embodiment of the invention, the first transparent conductive layer 1114 comprises strip-shaped electrodes extending along a direction, such as direction x, and the first transparent conductive layer 1114 can be formed of indium tin oxide (ITO) or indium zinc oxide (IZO). A second transparent conductive layer 1116 is disposed over the first transparent conductive layer 1114 with an interval layer 1118 between the first transparent conductive layer 1114 and the second transparent conductive layer 1116. The second transparent conductive layer 1116 comprises strip-shaped electrodes extending along a direction, such as direction y, and the second transparent conductive layer 1116 can be formed of indium tin oxide (ITO) or indium zinc oxide (IZO). The interval layer 1118 can be formed of glass. A third transparent conductive layer 1110 and an insulating layer 1112 are disposed between the first transparent conductive layer 1114 and the liquid crystal layer 1108. A second polarizing film 1122 is disposed on the second transparent conductive layer 1116. A metal trace layer 1120 is disposed between the second polarizing film 1122 and the second transparent conductive layer 1116. A cover 1128 is disposed over the second polarizing film 1122, wherein the cover 1128 can be glass, polymethylmethacrylate (PMMA) or a transparent thin film. An ink layer 1126 and optics glue 1124 are disposed between the cover 1128 and the second polarizing film 1122, wherein the ink layer 1126 is used to cover the periphery circuit in the non-display region.

According to the embodiments described, the liquid crystal display device having a touch operating device has the advantages as follows. First, the invention integrates a field sequential color (FSC) liquid crystal display device with a touch operating device and does not need color filters, so that thickness and weight of products can be reduced. Second, since FSC technology is used, product brightness can be increased.

While the invention has been described by way of example and in terms of the preferred embodiments, it is to be understood that the invention is not limited to the disclosed embodiments. It is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch operating display device, comprising:
a back light device;
a first polarizing film disposed on the back light device;
an operating device disposed on the first polarizing film;
a liquid crystal layer disposed on the operating device;
a first transparent conductive layer disposed on the liquid crystal layer;
an interval layer disposed on the first transparent conductive layer;
a second transparent conductive layer disposed on the interval layer; and
a second polarizing film disposed on the second transparent conductive layer.

2. The touch operating display device as claimed in claim 1, further comprising an ink layer and an optic glue disposed between the second transparent conductive layer and the second polarizing film.

3. The touch operating display device as claimed in claim 2, further comprising a black matrix layer disposed between the first transparent conductive layer and the liquid crystal layer.

4. The touch operating display device as claimed in claim 1, further comprising a cover disposed over the second polarizing film.

5. The touch operating display device as claimed in claim 4, further comprising an ink layer and an optic glue disposed between the cover and the second polarizing film.

6. The touch operating display device as claimed in claim 4, wherein the cover is glass, polymethylmethacrylate (PMMA) or a transparent thin film.

7. The touch operating display device as claimed in claim 2, further comprising a metal trace layer disposed between the ink layer and the second transparent conductive layer.

8. The touch operating display device as claimed in claim 2, further comprising a metal trace layer disposed under the first transparent conductive layer.

9. The touch operating display device as claimed in claim 2, further comprising a first metal trace layer disposed between the ink layer and second transparent conductive layer, and a second metal trace layer disposed under the first transparent conductive layer.

10. The touch operating display device as claimed in claim 1, further comprising a third transparent conductive layer disposed under the first transparent conductive layer, and an interval layer interposed between the first transparent conductive layer and the third transparent conductive layer.

11. The touch operating display device as claimed in claim 1, further comprising:
a third transparent conductive layer disposed under the first transparent conductive layer, and an interval layer interposed between the first transparent conductive layer and the third transparent conductive layer;
a cover disposed over the second polarizing film;
a ink layer and optic glue interposed between the cover and the second polarizing film; and
a second transparent conductive layer and a metal trace layer interposed between the ink layer and the second transparent conductive layer.

12. The touch operating display device as claimed in claim 1, wherein the operating device is a thin film transistor.

13. The touch operating display device as claimed in claim 1, wherein the backlight device is a light emitting diode array.

14. The touch operating display device as claimed in claim 1, wherein the liquid crystal layer is an optically compensated bend (OCB) liquid crystal layer.

15. The touch operating display device as claimed in claim 1, wherein the touch operating display device uses field sequential color (FSC) to present color.

16. The touch operating display device as claimed in claim 1, wherein the touch operating display device does not comprise a color filter.

17. The touch operating display device as claimed in claim 1, wherein the first transparent conductive layer, the interval layer and the second transparent conductive layer are used as a sensing device.

18. A touch operating display device, comprising:
a back light device;
a first polarizing film disposed on the back light device;
an operating device disposed on the first polarizing film;
a liquid crystal layer disposed on the operating device;
an interval layer disposed over the liquid crystal layer;
a first transparent conductive layer and an insulating layer disposed on the interval layer, wherein the first transparent conductive layer comprises strip-shaped structures extending along a first direction, and the first transparent conductive layer comprises strip-shaped electrodes extending along a second direction;
a connection layer disposed on the insulating layer, connecting to the strip-shaped electrodes disposed on two sides of the insulating layer;
a second transparent conductive layer disposed between the interval layer and the liquid crystal layer; and
a second transparent conductive layer disposed on the first transparent conductive layer.

19. The touch operating display device as claimed in claim 18, wherein the touch operating display device uses field sequential color (FSC) to present color.

20. The touch operating display device as claimed in claim 18, wherein the touch operating display device does not comprise a color filter.

21. The touch operating display device as claimed in claim 18, wherein the first transparent conductive layer, the interval layer and the second transparent conductive layer are used as a sensing device.

22. The touch operating display device as claimed in claim 18, wherein the liquid crystal layer is an optically compensated bend (OCB) liquid crystal layer.
